(19) United States
(12) Patent Application Publication
(10) Pub. No.: US 2023/0054664 A1
(43) Pub. Date: Feb. 23, 2023

(54) COMPOSTABLE MULTI-COMPONENT CONSTRUCTIONS

(71) Applicant: 3M INNOVATIVE PROPERTIES COMPANY, St. Paul, MN (US)

(72) Inventors: Mark V. Riofski, Eagan, MN (US); Ignatius A. Kadoma, Cottage Grove, MN (US); Mikhail A, Belkin, Chicago, IL (US); Kristy A. Jost, Woodbury, MN (US); Colby W. Dotseth, Baldwin, WI (US); Kenneth A. Cox, Woodbury, MN (US); Michael P. Mandanas, Little Canada, MN (US); Xiaoling Huang, Shanghai (CN); Wei Li Hu, Shanghai (CN)

(21) Appl. No.: 17/759,342

(22) PCT Filed: Jan. 22, 2021
(86) PCT No.: PCT/IB2021/050500

§ 371 Date: Jul. 22, 2022

Related U.S. Application Data
(60) Provisional application No. 62/965,476, filed on Jan. 24, 2020.

(51) Int. Cl. D01F 8/14; D01F 8/12; D01D 5/34; C08G 63/08; C08G 63/16; C08L 77/00; C08L 91/06

(52) U.S. Cl. CPC D01F 8/14; D01F 8/12; D01D 5/34; C08G 63/08; C08G 63/16; C08L 77/00; C08L 91/06; C08G 2230/00

(57) ABSTRACT

The present invention is a multi-component fiber includes a core and a sheathing surrounding the core. The core includes a first aliphatic polyester or copolymer of an aliphatic polyester. The sheathing includes a second aliphatic polyester or copolymer of an aliphatic polyester or a polyamide, and a hydrophobic agent. The second aliphatic polyester or copolymer of an aliphatic polyester or a polyamide has a melt flow index of between about 0.5 and about 19.5 g/10 min using a 2.16 Kg weight at 190° C.

### FIELD

The present application relates generally to compostable articles. In particular, the present application relates to compostable fibers used for textile goods.

### BACKGROUND

Polyester yarns and nonwovens are traditionally used to produce textile goods such as apparel and home goods. With the significant growing demands of the market, millions of tons of textile goods are produced each year. Often, these textiles goods are non-biodegradable and non-recyclable and once no longer of use, are deposited into landfills. The disposal of non-biodegradable and non-recyclable (non-renewable) waste is a pressing environmental challenge. As a response to growing waste worldwide, government regulations are being enacted to impose a “circular economy” by restricting landfill of synthetic non-degradable plastics and promoting compostable or biodegradable plastic alternatives. Bioplastic textiles and fibers are a renewable material that can replace traditional polyester yarns and nonwovens. While their use has expanded considerably, challenges involving limited material properties, for example hydrolytic stability, which can lead to macro challenges such as laundering durability currently make their use less prevalent.

### SUMMARY

In one embodiment, the present application is a multi-component fiber includes a core and a sheathing surrounding the core. The core includes a first aliphatic polyester or copolymer of an aliphatic polyester. The sheathing includes a second aliphatic polyester or copolymer of an aliphatic polyester or a polyamide, and a hydrophobic agent, wherein the second aliphatic polyester or copolymer of an aliphatic polyester or a polyamide has a melt flow index of between about 0.5 and about 19.5 g/10 min using a 2.16 Kg weight at 190° C.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The disclosure may be more completely understood in consideration of the following detailed description of various embodiments of the disclosure in connection with the accompanying drawings, in which:

FIG. 1 is a Scanning Electron Micrograph of multi-component fibers according to the present disclosure.

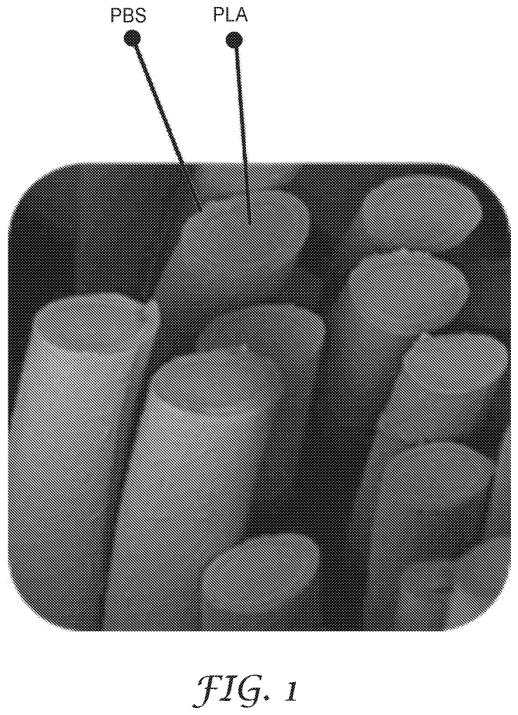

FIG. 2 shows a graph of the acoustic absorption of Example MCW-1, per ASTM 1050 (small tube).

While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

The present invention is a multi-component fiber including at least one bio-based polymer that is both biodegradable and compostable. In one embodiment, the present invention includes core and a sheathing. The core includes a first aliphatic polyester and the sheathing includes a second aliphatic polyester or a polyamide, wherein the second aliphatic polyester or polyamide is compounded with a hydrophobic agent and has a melt flow index of between about 0.5 and about 19.5 g/10 min using a 2.16 Kg weight at 190° C. The multi-component fiber can be used to produce, for example, blown microfiber, nonwoven webs, loose staple fibers, bonded staple fibers, entangled webs, combination webs of staple fibers and blown microfiber, filament nonwovens, yarns, staple spun, filament spun, monofilament, wovens, knits and any combination thereof and insulation. A particular advantage of the multi-component fiber of the present invention is that the multi-component fiber, and any articles constructed of the multi-component fibers, are completely biodegradable and compostable.

As used herein, a material is “degradable” when it is capable of degrading as a result of exposure to the environmental effects of sunlight, heat, water, oxygen, pollutants, microorganisms, insects and/or animals. Usually such materials are naturally occurring and are usually “biodegradable”. As used herein, “biodegradable” materials are those which are degraded by microorganisms or by enzymes and the like produced by such microorganisms. As used herein, “biodegradable” refers to materials or products that meet the requirements of ASTM D6400-12 (2012), which is the standard used to establish whether materials or products satisfy the requirements for labeling as “compostable in municipal and industrial composting facilities.”

As used herein, a material is “compostable” when it is capable of breaking down into natural elements in a compost environment. As used herein, “compostable” refers to materials that undergo degradation by biological processes during composting to yield carbon dioxide, water, inorganic compounds, and biomass at a rate consistent with other compostable materials and leaves no visible, distinguishable or toxic residue.

The multi-component fiber composition of the present invention imparts increased hydrophobicity providing improved hydrolytic stability, aiding in laudering and hindering premature degradation due to moisture. The multi-component fiber composition generally includes an aliphatic polyester or a copolymer of an aliphatic polyester core surrounded by a sheathing. The aliphatic polyester in the core functions to provide the multi-component fiber with improved tensile strength due to its high crystallinity while the sheathing and its components function to provide, for example, but not limited to, hydrolytic stability. In one embodiment, the aliphatic polyester or a copolymer of an aliphatic polyester core can include, but is not limited to: a poly(lactic acid) (PLA), a poly(glycolic acid), a poly(lactic-co-glycolic acid), a polyalkylene succinate such as polybutylene succinate (PBS), a polyalkylene adipate, a polyhydroxybutyrate (PHB), a polyhydroxy valerate (PHV), polyhydroxyhexanoate (PHH), polyhydroxybutyrate-hydroxyvalerate copolymers (PHBV), poly(butylene succinate-co-terephthalate (PBST), and combinations thereof In further embodiments, the core can include at least one of naturally occurring zein, polycaprolactone, cellulosic ester, and combinations thereof. In alternative embodiments that are not necessarily biodegradable, the core can include dimer acid polyamide. In one embodiment, the aliphatic polyester core is formed of polylactic acid (PLA).

When the core includes an aliphatic polyester that is a polylactic acid polymer or copolymer (e.g., a melt-processable material, in particular a fiber-forming resin), the core contains lactic acid monomer (repeat) units. Such polymers or copolymers may generally be derived from monomers chosen from any isomer of lactic acid, such as L-lactic acid, D-lactic acid, or mixtures thereof. Polylactic acid may also be formed from anhydrides of any isomer of lactic acid, including L-lactide, D-lactide, meso-lactide, or mixtures thereof. Cyclic dimers of such lactic acids and/or lactides may also be employed. Thus, for example, a L-lactic acid monomer unit of a polylactic acid will be understood as being derivable from a L-lactic acid monomer or from any source that provides an equivalent monomer unit in the thus-formed polymer. Any known polymerization method, such as polycondensation or ring-opening polymerization, may be used to produce such polymers.

A polylactic acid may be an L-lactic acid or D-lactic acid homopolymer; or, it may be a copolymer, such as one that contains L-lactic acid monomer units and D-lactic acid monomer units. (In such polymers, a homopolymer or copolymer designation will be a “stereo” designation based on the tacticity of the monomer units rather than on the chemical composition). Again, such monomer units may be derived from the incorporation into the copolymer chain of L-lactic acid, D-lactic acid, L-lactide, D-lactide, meso-lactide, and so on. In some embodiments, a polylactic acid may be an L-D copolymer comprised predominately of L-lactic acid monomer units along with a small amount of D-lactic acid monomer units (which may, e.g., improve the melt-processability of the polymer).

PLA is a biodegradable polymer derived from renewable sources such as corn starch and sugarcane. It is a thermoplastic polyester with a high melting point (i.e., 150 to 160° C.). Several documents have described the use of PLA in biodegradable compositions. For example, U.S. Patent Publication No. 2009/0324917, which is hereby incorporated by reference, describes a biodegradable film comprising a blend of a thermoplastic starch, a polylactic acid, and at least one aliphatic-aromatic copolyester.

The sheathing composition provides improved processability for a high viscosity resin, improved laundering durability due to increased hydrophobicity character, and good tensile strength to the multi-component fiber. The sheathing includes an aliphatic polyester or a copolymer of an aliphatic polyester or a polyamide as its base composition. If the sheathing includes an aliphatic polyester, the aliphatic polyester may be the same as or different than the aliphatic polyester in the core. In one embodiment, the sheathing can include, but is not limited to: a poly(lactic acid) (PLA), a poly(glycolic acid), a poly(lactic-co-glycolic acid), a polyalkylene succinate such as polybutylene succinate (PBS), a polyalkylene adipate, a polyhydroxybutyrate (PHB), a polyhydroxy valerate (PHV), polyhydroxyhexanoate (PHH), polyhydroxybutyrate-hydroxyvalerate copolymers (PHBV), poly(butylene succinate-co-terephthalate (PBST), and combinations thereof In further embodiments, the sheathing includes at least one of naturally occurring zein, polycaprolactone, cellulosic ester and combinations thereof In alternative embodiments that are not necessarily biodegradable, the sheathing may include dimer acid polyamide. In one embodiment, the sheathing is formed from a polybutylene succinate (PBS). PBS is a thermoplastic aliphatic polyester that decomposes naturally into water and carbon dioxide in the presence of microorganisms such as, for example, Amycolatopsis sp. HT-6, and Penicillium sp. Strain 14-3. In addition, PBS has a lower melting point (i.e., 84° C.) and is a malleable polymer, which imparts a soft hand feel. The PBS in the sheathing of the present invention has a number average molecular weight above 125,000 Daltons with a melt flow index of viscosity of between about 0.5 and about 19.5 g/10min using a 2.16 Kg weight at 190° C. In general, relatively high molecular weight of a polymer increases the material's ability to stretch before failure, as well as impact resistance due to a higher degree of polymer chain entanglement. Furthermore, relatively high molecular weight of a polymer increases the material's chemical resistance. However, high molecular weight polymers also increase the viscosity of the material, making thermal processing more difficult.

The base sheathing composition (i.e., PBS) is compounded with a hydrophobic agent, such as a wax, to increase hydrophobicity. Generally, if the water contact angle on a surface is less than 90° , the surface is considered hydrophilic. If the water contact angle on the surface is greater than 90° , the surface is considered hydrophobic. The high viscosity PBS and hydrophobic agent construction imparts hydrophobicity of the sheathing and increases the hydrolytic stability of the base sheathing composition. Having hydrolytic stability aids in the laundering performance of the multi-component fiber. In one embodiment, the multi-component fiber of the present invention is hydrophobic with a water contact angle of greater than about 90°, particularly greater than about 100°, and more particularly greater than about 110°.

Examples of suitable hydrophobic agents include both bio-based and non-bio-based rheology modifiers. Exemplary hydrophobic agents include, but are not limited to: ethylene bis(stearamide) (EBS), castor wax, polyamitic acid, lionol leic acid, arachandoric acid, polantolic acid, butric acid, steric acid, and triglyceride. In one embodiment, the hydrophobic agent is a plant-based wax. Examples of suitable plant-based waxes include, but are not limited to: castor wax, ethylene bis(stearamide) (EBS), and soy wax. Alcohols are not suitable hydrophobic agents for the present invention as they may reduce stability. In one embodiment, the sheathing includes ethylene bis(stearamide) (EBS) which further improves hand-feel, abrasion resistance, water resistance and anti-static properties. In one embodiment, the sheathing includes a surfactant, for example, Hetoxamide C-4, JDOSS 50P, or combinations thereof which further improves anti-static properties and processability. In one embodiment, the sheathing includes at least about 0.1% hydrophobic agent. In one embodiment, the sheathing includes about 25% or less, particularly about 10% or less, more particularly about 8% or less, and even more particularly about 5% or less hydrophobic agent. When the sheathing includes more than about 10% hydrophobic agent, the hydrophobic agent may begin to embrittle the fibers.

The base sheathing composition (i.e., PBS) can be compounded with a rheology modifier, such as a wax, to lower the melt viscosity of the sheathing and thus improve processability of the multicomponent fiber. The rheology modifier can function to both modify the rheology or impart hydrophobic or hydrophilic properties to the sheathing. The rheology modifier lowers the melt viscosity of the sheathing so that the multi-component fiber is spinnable into a fiber. In addition, the combination of the base sheathing composition and the rheology modifier also provides water and stain resistance to the multi-component fiber.

The sheathing may also include a high melting point, high melt flow index (MFI) polymer. MFI is a measurement of melt viscosity or flowability of a material. The higher the MFI, the lower the melt viscosity of a material. The use of a high melting point, high melt flow index polymer in the sheathing generally aids with the drawability of the fiber by lowering the overall viscosity of the sheathing to allow for stable spinning conditions for an extended spinning run (i.e., over 24 hours). Drawing a fiber helps to induce crystallinity which governs the shelf stability and tenacity (less shrinkage) of the fiber. In one embodiment, the high melting point, high melt flow index polymer has a MFI of at least about 22, particularly at least about 40, more particularly at least about 65, and even more particularly at least about 70. In one embodiment, the melting point of the high melting point, high melt flow index polymer in the sheathing is no more than about 20° C. below the melting point of the aliphatic polyester core. In one embodiment, the high melting point, high melt flow index polymer has a melting point of at least about 165 ° C., particularly at least about 170° C., and more particularly at least about 175° C. In one embodiment, the high melting point, high melt flow index polymer is a polyamide or an aliphatic polymer, such as, for example, PLA. An example of a commercially suitable PLA is Ingeo PLA 6252 from Natureworks, located in Minnetonka, Minn.

In one embodiment, the sheathing includes between about 70-98% aliphatic polyester or polyamide and between about 2-30% hydrophobic agent, particularly between about 70-95% aliphatic polyester or polyamide and between about 5-30% hydrophobic agent, more particularly between about 90-95% aliphatic polyester or polyamide and between about 5-10% hydrophobic agent, and even more particularly about 95% aliphatic polyester or polyamide and about 5% hydrophobic agent. In another embodiment, the sheathing includes between about 40-75% aliphatic polyester or polyamide, between about 15-58% high melting point, high melt flow index polymer, and between about 2-10% hydrophobic agent, more particularly between about 45-70% aliphatic polyester or polyamide, between about 20-50% high melting point, high melt flow index polymer, and between about 5-10% hydrophobic agent, and more particularly about 65% aliphatic polyester or polyamide, about 30% high melting point, high melt flow index polymer, and about 5% hydrophobic agent. In one embodiment, the sheathing includes polybutylene succinate, polylactic acid, and castor wax.

Other additives can be added to the multi-component fiber composition to provide desired results. Examples include, but are not limited to: anti-static agents, slip agents, hydrophilic agents hydrophobic agents, surfactants, inorganic particles, electrically conductive materials, and pigments for differentiation. In one embodiment, the multi-component fiber includes between about 30 and about 80% core and between about 20 and about 70% sheathing, particularly between about 50 and about 80% core and between about 20 and about 50% sheathing, and more particularly between about 70 and about 80% core and between about 20 and about 30% sheathing.

The core and sheathing have a range of melt viscosity indexes to enable spinning into a multi-component fiber. In one embodiment, the core has a melt flow index (MFI) of between about 15 and about 30g/lOmin at 210° C., particularly between about 20 and about 30g/lOmin at 210° C., and more particularly between about 25 and about 30 g/10min at 210° C. In one embodiment, the sheath is composed of PBS and a wax and has a melt flow index (1VIFI) of between about 15 and about 30 g/10min at 215° C., particularly between about 18 and about 30 g/10min at 215° C., and more particularly between about 20 and about 30 g/10min at 215° C. In one embodiment, the sheath is composed of PBS, wax, and PLA and has a melt flow index (MFI) of between about 20 and about 100 g/10 min at 215° C., particularly between about 30 and about 100 g/10 min at 215° C., and more particularly between about 60 and about 100 g/10 min at 215° C. In one embodiment, the base sheathing composition has a melt flow index of between about 0.5 and about 19.5 g/10 min using a 2.16 Kg weight at 190° C.

The multi-component fibers may take on any shape known to those of skill in the art. While the present application focuses on the core-sheath shape, the multi-component fibers may take on any shape known to those of skill in the art without departing from the intended scope of the present invention. For examples, fiber shapes may include, but are not limited to: trilobal, core-sheath, multilayered delta, or hollow.

As previously mentioned, the multi-component fiber composition is hydrophobic. One reason is that certain hydrophilic materials will slowly degrade via hydrolysis (i.e., when a material chemically reacting with water). This can affect the shelf life as well as thermal insulation properties of the multi-component fiber. In one embodiment, the multi-component fiber is stable for at least 1 week, at least 2 weeks, at least 3 weeks, at least 4 weeks, at least 5 weeks, at least 6 weeks, and at least 7 weeks after being subjected to temperatures of about 55° C. and humidity of about 95% per ASTMF-1980. This corresponds to the multi-component fiber having a stable shelf life for at least about 2 months, at least about 4 months, at least about 6 months, at least about 8 months, at least about 10 months, at least about 12 months, and at least about 14 months.

The multi-component fibers of the present invention can be made according to the process described in Patent Publication WO1999051799, which is hereby incorporated by reference.

The multi-component fibers of the present invention can be blended with other fibers or materials. Examples include, but are not limited to: cellulosic materials (natural or manufactured), protein-based fibers, and feathers. Examples of cellulosic materials include, but are not limited to: cotton, rayon, lyocell, Tencel, and linen. Examples of protein-based fibers include those derived from the hair of mammals, such as wool, alpaca and cashmere, as well as those derived from web-spinning insects or arachnids, naturally or synthetically produced in forms other than the fiber itself.

The multi-component fibers of the present invention can be used to form nonwovens, yarns, wovens, and knits for use in producing textile goods. When the multi-component fibers are used to produce nonwovens, the multi-component fibers can be, for example and without limitation: loose staple fibers, bonded staple fibers, entangled webs (i.e., needletack or hydro-entangled), meltbown, meltblown combination webs (i.e., as a staple fiber blended with meltblown biodegradable or compostable fibers), filament nonwoven webs, or staple fibers or nonwoven from fibrillated films. The aforementioned raw material resins themselves for the core and sheathing (e.g., PBS, PLA, etc.) can also be meltblown directly into fibers. When the multi-component fibers are used to produce yarns, the multi-component fibers can be, for example and without limitation, staple spun, filament spun, or monofilaments. In one embodiment, when the multi-component fibers are used to produce wovens, the multi-component fibers can be tightly woven so as to provide water resistance such that moisture cannot easily permeate the fabric. In one embodiment, when the multi-component fibers are used to produce knits, the multi-component fibers can be used to create wicking properties. In one embodiment, the multi-component fibers are used to form double knits, for example, with a hydrophobic face and a hydrophilic back. In one embodiment, the multi-component fibers can be used in bonded batt format or a meltblown combination web format.

The multi-component fibers, once in yarn or nonwoven form can be used in various applications. Examples include, but are not limited to: thermal insulation, acoustic insulation, wicking textiles, waterproof textiles, fabrics with inherent stain resistance to water-based stains, compostable towels, cleaning cloths, and cleaning/dusting nonwovens.

The applications can be useful in various markets, including, but not limited to: apparel, housing/interiors, automotive, furniture, flooring, tents/waterproof outdoor fabrics, carpet, and home cleaning.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

Foreseeable modifications and alterations of this disclosure will be apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

### EXAMPLES

### Materials

| Material | Supplier |
|---|---|
| BioPBS FZ71 | Poly butylene succinate resin, available from |
| | PTT MCC Biochem Company Limited, Bangkok, |
| | Thailand |
| Luminy L130 | Polylactide resin available from Total Corbion, |
| | The Netherlands |
| Ingeo PLA 6252 | Polylactide resin, available from NatureWorks |
| | LLC, Minnentonka, MN (USA) |
| 820 PLA for PLA | Fiber obtained from Haining Xin Neng Fibers |
| 4D fiber | & Non-wovens Limited (China) |
| 828 PLA/PLA for | Fiber obtained from Haining Xin Neng Fibers |
| PLA fiber LMF 2D | & Non-wovens Limited (China) |
| Hydrolysis resistant | Fibers obtained from Shanghai Huayu new |
| PLA LMF 4D fiber | materials Limited (China) |
| Hydrolysis resistant | Fibers obtained from Shanghai Huayu new |
| PLA 6D fiber | materials Limited (China) |
| PBS fiber | Fiber obtained from Shaoxing Global Chemical |
| | Fiber Co., Ltd |
| Hetoxamide C-4 | Surfactant obtained from Global Seven, NJ, |
| surfactant | (USA) |
| JDOSS 50P surfactant | Surfactant obtained from JLK Industries, PA |
| | (USA) |
| Castor Wax MP-80 | Plant based wax from Vertellus, Indianapolis, |
| | IN (USA) |

### Test Methods

Contact angle measurements were performed in accordance with ASTM D5725-99(2008).

Accelerated aging/shelf-life stability testing at elevated temperature and humidity conditions were performed in accordance with ASTM F-1980. Under ASTM F-1980, the accelerated aging procedures were used with constant temperatures above room conditions and constant humidity. 50° C/55° C. and 95% RH were chosen as the test conditions. The fiber samples were placed into an open ziplock bag and then kept at the test conditions. Changes in fiber tensile strength and appearance were detected every seven days. After being subjected to the accelerated aging/shelf-life stability test, the fibers were rated on a scale of 0 to 4, with 0 indicating single fiber into molten droplet, 1 indicating single fiber into powder, 2 indicating single fiber no strength, 3 indicating single fiber has little strength (brittle), and 4 indicating single fiber has strength.

Insulation was characterized by the following test methods:

Thickness: Measured in accordance with ASTM D 5736 using a pressure of 0.002 psi.

Thermal Resistance: Measured by one of two methods: 1) on a guarded hot plate in accordance with ASTM F 1868 and reported in units of “do”, and 2) on a Heat Flow Meter device in accordance with ASTM C 518 operating at a mean sample temperature of 30° C. and at the sample thickness obtained from the 0.002 psi thickness measurement. A thermal weight efficiency (TWE) was obtained by dividing the resultant thermal resistance (clo units) by the product weight (units of Kg/m²). A thickness efficiency was obtained by dividing the thermal resistance (clo) by the thickness (units of cm).

Acoustic Absorption: Measured in accordance with ASTM E 1050.

Laundering: 21″×21″ or 12″×12″ sized panels of insulation were sewn up between 65 g/m² nylon ripstop fabric then laundered the equivalent to 5 or 10 times in a top loading Home Washer and front loading Home Dryer: Machine Wash Cold (≤30° C/85° F.), Delicate Cycle; Tumble Dry Low Heat.

### EXAMPLES

An exemplary fiber making process is disclosed in, for example, Patent Publication WO1999051799, which is hereby incorporated by reference. This process was used for making for the following examples.

### Example 1

Sheath: BioPBS FZ91 +5% Castorwax

Core: Luminy L130

3 denier, 31 mm

### Example 2

820 PLA for PLA 4D fiber

### Example 3

828 PLA/PLA for PLA fiber LMF 2D

### Example 4

Hydrolysis resistant PLA LMF 4D fiber

### Example 5

Hydrolysis resistant PLA 6D fiber

### Example 6

PBS fiber

The results of the contact angle measurements are shown below in Table 1.

TABLE 1

| Film | Contact Angle (degrees) |
|---|---|
| BioPBS FZ71 | 68.5 |
| Polyethylene (Ziploc Bag) | 97 |
| Teflon Tape | 107 |
| BioPBS FZ71 + 1% wax | 125 |

The results of the accelerated aging and shelf-life are shown below in Tables 2 (at 50° C. and 95% humidity) and 3 (at 55° C. and 95% humidity).

TABLE 2

| | 50° C., 95% | | | | | | | | | | | | | | | | | | |
|---|---|---|---|---|---|---|---|---|---|---|---|---|---|---|---|---|---|---|---|
| | 1 W | 2 W | 3 W | 4 W | 5 W | 6 W | 7 W | 8 W | 9 W | 10 W | 11 W | 12 W | 13 W | 14 W | 15 W | 16 W | 17 W | 18 W | 19 W |
| | Shelf life estimation (months) | | | | | | | | | | | | | | | | | | |
| | 1.5 | 3 | 4.5 | 6 | 7.5 | 9 | 10.5 | 12 | 13.5 | 15 | 16.5 | 18 | 19.5 | 21 | 22.5 | 24 | 25.5 | 27 | 28.5 |
| PLA LMF | | | | | | | | | | | | | | | | | | | |
| 2 D | | | | | | | | | | | | | | | | | | | |
| PLA 4 D | | | | | | | | | | | | | | | | | | | |
| Hydrolysis | | | 4− | | | | | | | | | | | | | | | | |
| resistant | | | | | | | | | | | | | | | | | | | |
| PLA LMF | | | | | | | | | | | | | | | | | | | |
| 4 D | | | | | | | | | | | | | | | | | | | |
| Hydrolysis | | | | | | | | | | | | | | | | | | | |
| resistant | | | | | | | | | | | | | | | | | | | |
| PLA 6 D | | | | | | | | | | | | | | | | | | | |
| PBS 2 | | 4 | 4 | 4 | 4 | 4 | 4− | | | | | | | | | | | | |
| D*38 mm | | | | | | | | | | | | | | | | | | | |
| PLA/PBS | 4 | 4 | 4 | 4 | 4 | 4 | 4 | 4 | 4 | 4 | 4 | 4 | 4 | 4 | 4 | 4 | 4 | 4 | 3 |
| 3 D*31 mm | | | | | | | | | | | | | | | | | | | |

TABLE 3

| | 55° C., 95% | | | | | | | | | | | | | | |
|---|---|---|---|---|---|---|---|---|---|---|---|---|---|---|---|
| | 1 W | 2 W | 3 W | 4 W | 5 W | 6 W | 7 W | 8 W | 9 W | 10 W | 11 W | 12 W | 13 W | 14 W | 15 W |
| | Shelf life estimation (months) | | | | | | | | | | | | | | |
| | 2 | 4 | 6 | 8 | 10 | 12 | 14 | 16 | 18 | 20 | 22 | 24 | 26 | 28 | 30 |
| PLA LMF | 2 | 1 | 1− | 1− | 0 | | | | | | | | | | |
| 2 D | | | | | | | | | | | | | | | |
| PLA 4 D | 4 | | 3+ | 1− | | | 1 | | | | | | | | |
| Hydrolysis | 4 | | 3 | 2+ | | | 1+ | | | | | | | | |
| resistant | | | | | | | | | | | | | | | |
| PLA LMF | | | | | | | | | | | | | | | |
| 4 D | | | | | | | | | | | | | | | |
| Hydrolysis | 4+ | | 4 | | | | 3 | | | | | | | | |
| resistant | | | | | | | | | | | | | | | |
| PLA 6 D | | | | | | | | | | | | | | | |
| PBS 2 | | 4 | 4 | 4 | 4 | 4− | 4− | 3+ | 3 | 2 | | | | | |
| D*38 mm | | | | | | | | | | | | | | | |
| Example 2 | 4 | 4 | 4 | 4 | 4 | 4 | 4 | 4 | 4 | 4 | 4 | 4 | 4 | 3 | |
| PLA/PBS | | | | | | | | | | | | | | | |
| 3 D*31 mm | | | | | | | | | | | | | | | |

Insulation Examples LF-1 through LF-8: Loose Fill fibrous Insulation including blends of:

1) 30% PBS+Wax Sheath/70% PLA Core having a cut length of 32 mm and nominal denier of 2 (actual denier of 2.5), and

2) 25% PBS+Wax Sheath/75% PLA Core having a cut length of 27 mm and nominal denier of 3 (actual denier of 3.2).

These blends were sewn up into 12″×12″ panels between nylon ripstop in 3″ channels via either a “Channel Fill” method (in which the channels were sewn first and then the insulation blend conveyed into the channels), or a “Direct Sewn” method (in which the insulation was conveyed into the 12″×12″ panel and then the 3″ quilt linesewn over the assembly). In both cases, an insulation weight of 300 g/m² was used. Results are shown in Table 4.

TABLE 4

| | | Panel | | Thickness | | | Thermal Resistance | | | | |
|---|---|---|---|---|---|---|---|---|---|---|---|
| | | Insulation | | ASTM D 5736 | | | ASTM C 518 | | | | |
| | | Fill | | @ 0.002 psi | | | @ 0.002 psi Thickness | | | Initial | Initial |
| | | Method. | | Before | After | | Before | After | | Thermal | Thermal |
| | | Channel | Target | 10X | 10X | | 10X | 10X | | Weight | Thickness |
| Patent | | Fill/ | Fill | Laun- | Laun- | Thickness | Laun- | Laun- | clo | Efficiency | Efficiency |
| Example | | Direct | Weight | dering | dering | % | dering | dering | % | clo/ | clo/ |
| Label | Formulation | Sewn | g/m² | cm | cm | Retention | clo | clo | Retention | (kg/m²) | cm |
| Example | 100% 2 dpf | Channel | 300 | 3.2 | 2.7 | 84% | 4.1 | 2.1 | 50% | 13.7 | 1.3 |
| LF-1 | | Fill | | | | | | | | | |
| Example | 80% 2 dpf/ | Channel | 300 | 3.3 | 2.5 | 74% | 4.1 | 2.3 | 57% | 13.6 | 1.2 |
| LF-2 | 20% 3 dpf | Fill | | | | | | | | | |
| Example | 60% 2 dpf/ | Channel | 300 | 3.4 | 2.3 | 68% | 4.3 | 1.9 | 44% | 14.4 | 1.3 |
| LF-3 | 40% 3 dpf | Fill | | | | | | | | | |
| Example | 40% 2 dpf/ | Channel | 300 | 3.3 | 2.9 | 87% | 4.2 | 2.1 | 51% | 13.9 | 1.3 |
| LF-4 | 60% 3 dpf | Fill | | | | | | | | | |
| Example | 100% 2 dpf | Direct | 300 | 3.0 | 2.1 | 70% | 4.3 | 2.5 | 58% | 14.4 | 1.4 |
| LF-5 | | Sewn | | | | | | | | | |
| Example | 80% 2 dpf/ | Direct | 300 | 2.8 | 2.0 | 73% | 4.2 | 2.8 | 67% | 14.0 | 1.5 |
| LF-6 | 20% 3 dpf | Sewn | | | | | | | | | |
| Example | 60% 2 dpf/ | Direct | 300 | 3.0 | 2.2 | 76% | 4.4 | 2.9 | 67% | 14.5 | 1.5 |
| LF-7 | 40% 3 dpf | Sewn | | | | | | | | | |
| Example | 40% 2 dpf/ | Direct | 300 | 3.2 | 2.2 | 69% | 4.6 | 2.9 | 62% | 15.3 | 1.4 |
| LF-8 | 60% 3 dpf | Sewn | | | | | | | | | |

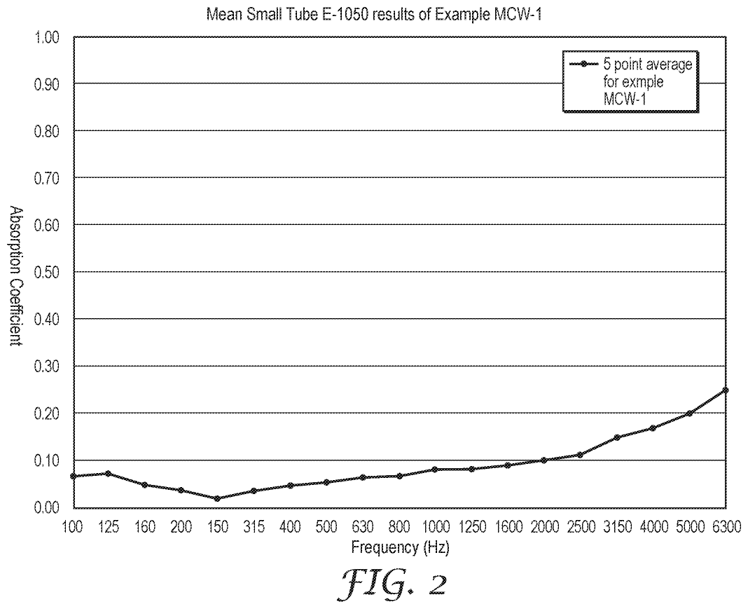

The Acoustic Absorption per ASTM 1050 E (small tube) was determined for Example MCW-1. Results are shown in Table 5 and FIG. 2.

TABLE 5

| Frequency (HZ) | Absorption Coefficient |
|---|---|
| 100 | 0.07 |
| 125 | 0.07 |
| 160 | 0.05 |
| 200 | 0.04 |
| 250 | 0.02 |
| 315 | 0.03 |
| 400 | 0.05 |
| 500 | 0.05 |
| 630 | 0.06 |
| 800 | 0.07 |
| 1000 | 0.08 |
| 1250 | 0.08 |
| 1600 | 0.09 |
| 2000 | 0.10 |
| 2500 | 0.11 |
| 3150 | 0.15 |
| 4000 | 0.17 |
| 5000 | 0.20 |
| 6300 | 0.25 |

Insulation Examples BB-1 and BB-2: Bonded Batts were obtained by using the multi-component fiber samples as a thermal bonding fiber in a carding/crosslapping/bonding process. Formulations included blends of:

1) 30% PBS +Wax Sheath/70% PLA Core having a cut length of 51 mm and nominal denier of 2 (actual denier of 2.5), and

2) Tencel® fibers having a cut length of 60 mm and nominal dtex of 6.7. The carded and crosslapped insulation webs were bonded at 120° C. Results are shown in Table 6.

TABLE 6

| | | | Thickness | | Initial | Initial |
|---|---|---|---|---|---|---|
| | | | ASTM D | Thermal | Thermal | Thermal |
| | | | 5736 | Resistance | Weight | Thickness |
| Patent | | | @ 0.002 | ASTM F | Efficiency | Efficiency |
| Example | | Weight | psi | 1868 | clo/ | clo/ |
| Label | Formulation | g/m² | cm | clo | (kg/m²) | cm |
| BB-1 | 100% 2 d*51 mm | 105 | 1.6 | 2.0 | 19 | 1.2 |
| | PBS/PLA | | | | | |
| BB-2 | 70% 2 d*51 mm | 112 | 2.4 | 2.1 | 19 | 0.9 |
| | PBS/PLA + 30% | | | | | |
| | Tcncel | | | | | |
| | 6.7 dtex*60 mm | | | | | |

Unless otherwise noted, all parts, percentages, ratios, etc. in the examples and the rest of the specification are by weight, and all materials used in the examples were used as obtained from the suppliers.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. A multi-component fiber comprising:
a core comprising a first aliphatic polyester or copolymer of an aliphatic polyester; and
a sheathing surrounding the core, wherein the sheathing comprises:
a second aliphatic polyester or copolymer of an aliphatic polyester or a polyamide; and
a hydrophobic agent,
wherein the second aliphatic polyester or copolymer of an aliphatic polyester or a polyamide has a melt flow index of between about 0.5 and about 19.5 g/10 min using a 2.16 Kg weight at 190° C., and wherein a polylactic acid is present in the sheathing.

2. The multi-component fiber of claim 1, wherein the second aliphatic polyester or copolymer of an aliphatic polyester or a polyamide comprises polybutylene succinate.

3. The multi-component fiber of claim 1, wherein the sheathing consists essentially of the second aliphatic polyester or copolymer of an aliphatic polyester or a polyamide and the hydrophobic agent.

4. (canceled)

5. (canceled)

6. The multi-component fiber of claim 1, wherein the hydrophobic agent comprises a wax.

7. The multi-component fiber of claim 1, wherein the hydrophobic agent comprises a pant-based wax.

8. The multi-component fiber of claim 7, wherein the plant-based wax is selected from the group consisting of castor wax, ethylene bis(stearamide) (EBS), and soy wax.

9. The multi-component fiber of claim 1, comprising between about 30 and about 80% core and between about 20 and about 70% sheathing.

10. The multi-component fiber of claim 1, wherein the sheathing comprises about 65% polybutylene succinate, about 30% polylactic acid, and about 5% plant-based wax.

11. The multi-component fiber of claim 1, wherein the sheathing comprises about 65% polybutylene succinate, about 30% polylactic acid, and about 5% plant-based wax.

12. The multi-component fiber of claim 1, wherein the first aliphatic polyester or copolymer of an aliphatic polyester comprises polylactic acid.

13. The multi-component fiber of claim 1, wherein the first aliphatic polyester or copolymer of an aliphatic polyester and the second aliphatic polyester or copolymer of an aliphatic polyester or a polyamide are the same.

14. The multi-component fiber of claim 1, wherein the first aliphatic polyester or copolymer of an aliphatic polyester and the second aliphatic polyester or copolymer of an aliphatic polyester or a polyamide are different.
